(19) United States
(12) Patent Application Publication
(10) Pub. No.: US 2026/0178524 A1
(43) Pub. Date: Jun. 25, 2026

(54) HIGH-SPEED OPTICAL COMMUNICATION CONNECTOR AND SERVER

(71) Applicant: SUZHOU METABRAIN INTELLIGENT TECHNOLOGY CO., LTD., Suzhou, Jiangsu (CN)

(72) Inventors: Sanxia CHEN, Suzhou, Jiangsu (CN); Tiejun LIU, Suzhou, Jiangsu (CN); Jing JI, Suzhou, Jiangsu (CN); Peiqiang DONG, Suzhou, Jiangsu (CN)

(21) Appl. No.: 19/140,425

(22) PCT Filed: Sep. 29, 2024
(86) PCT No.: PCT/CN2024/122479

§ 371 Date: Mar. 16, 2026

(30) Foreign Application Priority Data
Dec. 20, 2023 (CN) 202311764063.X

(51) Int. Cl. G06F 13/38; G06F 3/06; G06F 13/28; G06F 13/40; G06F 13/42

(52) U.S. Cl. CPC G06F 13/385; G06F 3/061; G06F 13/28; G06F 13/4027; G06F 13/4282

(57) ABSTRACT

Embodiments of the present application relate to the technical field of data transmission, and provide a high-speed optical communication connector and a server. Multiplexing of a module low-speed signal MODSEL and a negative clock signal is realized by means of a first signal pin, and multiplexing of an optical module reset signal or a positive clock signal is realized by means of a second signal pin, so that a high-speed optical communication connector comprising the first signal pin and the second signal pin can achieve both optical signal data transmission and PCIe protocol signal transmission, long-distance data transmission of PCIE bus data is achieved on the basis of an existing optical fiber network, the transmission efficiency of the PCIE bus data is improved, and resource waste of existing network infrastructure is avoided.

### CROSS-REFERENCE TO RELATED APPLICATION

This application claims the priority of the Chinese Patent application filed on Dec. 20, 2023 before the CNIPA, China National Intellectual Property Administration with the application number of 202311764063.X, and the title of “HIGH-SPEED OPTICAL COMMUNICATION CONNECTOR AND SERVER”, which is incorporated herein in its entirety by reference.

### FIELD

The present application relates to the technical field of data transmission and more particularly, to a high-speed optical communication connector and a server.

### BACKGROUND

Quad small form-factor pluggable 28 (QSFP28) is a high-speed optical fiber transmission module, which is a commonly used optical fiber interface standard in modern communication networks. The QSFP28 standard defines a high-performance optical fiber transmission module with a physical interface that adopts an embedded interface structure. This interface structure supports data transmission across up to 28 channels, with each channel having a transmission rate of up to 25 Gbit/s. Therefore, the QSFP28 module may achieve an overall transmission rate of up to 700 Gbit/s.

Today, 100 G optical fiber network ports have been increasingly applied, and 100 G port modules come in various packaging forms, including C form-factor pluggable (CFP)/CFP2/CFP4, 120 Gb/s extended-capability Form Factor Pluggable Module (CXP), and QSFP28. Among these different 100 G packaging form factors, the QSFP28 optical module has become a main packaging form for 100 G networks due to its high port density, low power consumption, low cost, etc. The QSFP28 is implemented with four 25 Gbps channels, and additionally, the QSFP28 optical module is equipped with an upgraded electrical interface that supports signals up to 28 G, each of the 4 channels achieving a highest potential rate of 28 Gbit/s. Packaging dimensions of the 100 G QSFP28 optical module are smaller than those of a CXPCFP4 optical module, enabling the higher port density on a switch.

Peripheral component interconnect express (PCI-Express) is a high-speed serial computer expansion bus standard. PCIe belongs to a high-speed, serial, point-to-point dual-channel high-bandwidth transmission, where connected devices are allocated an exclusive channel bandwidth, without sharing a bus bandwidth. It primarily supports active power management, error reporting, end-to-end reliable transmission, hot swapping, quality of service (QoS), and other functions.

However, current QSFP28 interfaces are not compatible with a PCIe protocol, resulting in inefficient data transmission over a PCIe bus and causing resource wastes in network infrastructure.

### SUMMARY

Embodiments of the present application provide a high-speed optical communication connector and a server to overcome the above-mentioned problems or at least solve part of the above-mentioned problems.

The embodiments of the present application disclose a high-speed optical communication connector QSFP28-PCIE, wherein the high-speed optical communication connector QSFP28-PCIE is configured to connect a host device and an optical module device or connect the host device and a non-transitory memory express (NVMe) device; and the host device is configured to generate a module low-speed signal MODSEL and an optical module reset signal, or to generate a negative clock signal CLK_N and a positive clock signal CLK_P. The high-speed optical communication connector QSFP28-PCIE includes:
a first signal pin for the module low-speed signal MODSEL or the negative clock signal CLK_N;
a second signal pin for the optical module reset signal or the positive clock signal CLK_P;
the first signal pin is configured to transmit the module low-speed signal MODSEL transmitted by the host device to the optical module device when the host device is connected to the optical module device;
the first signal pin is configured to transmit the negative clock signal CLK_N transmitted by the host device to the non-transitory memory express (NVMe) device when the host device is connected to the non-transitory memory express (NVMe) device;
the second signal pin is configured to transmit the optical module reset signal transmitted by the host device to the optical module device when the host device is connected to the optical module device; and
the second signal pin is configured to transmit the positive clock signal CLK_P transmitted by the host device to the non-transitory memory express (NVMe) device when the host device is connected to the non-transitory memory express (NVMe) device.

In some embodiments, the host device is provided with a field programmable gate array FPGA that is configured to receive an in-place detection input signal MODPRSL generated by the optical module device or the non-transitory memory express (NVMe) device, and when receiving the in-place detection input signal MODPRSL, the field programmable gate array FPGA is configured to establish a connection relationship between the host device and the optical module device based on the in-place detection input signal MODPRSL, or establish a connection relationship between the host device and the non-transitory memory express (NVMe) device based on the in-place detection input signal MODPRSL.

In some embodiments, including:
a third signal pin, configured to supply a signal receiving power voltage VCCRX;
a fourth signal pin, configured to supply a signal transmission power voltage VCCTX; and
a fifth signal pin, configured to supply a low-speed signal power voltage VCC1.

In some embodiments, the host device is configured to generate a linear polarization mode signal LPMODE or a peer device reset signal, and the high-speed optical communication connector QSFP28-PCIE includes:
a sixth signal pin for the linear polarization mode signal LPMODE or the peer device reset signal;
the sixth signal pin is configured to transmit the linear polarization mode signal LPMODE transmitted by the host device to the optical module device when the host device is connected to the optical module device; and
the sixth signal pin is configured to transmit a peer device reset signal transmitted by the host device to the non-transitory memory express (NVMe) device when the host device is connected to the non-transitory memory express (NVMe) device.

In some embodiments, the host device is configured to generate a terminal alarm signal INTC or a wake-up signal WAKE, and the high-speed optical communication connector QSFP28-PCIE includes:
a seventh signal pin for the terminal alarm signal INTC or the wake-up signal WAKE;
the seventh signal pin is configured to transmit the terminal alarm signal INTC transmitted by the host device to the optical module device when the host device is connected to the optical module device; and
the seventh signal pin is configured to transmit the wake-up signal WAKE transmitted by the host device to the non-transitory memory express (NVMe) device when the host device is connected to the non-transitory memory express (NVMe) device.

In some embodiments, the optical module device and the high-speed optical communication connector QSFP28-PCIE includes:
an eighth signal pin for the in-place detection input signal MODPRSL;
the eighth signal pin is configured to transmit the in-place detection input signal MODPRSL to the host device.

In some embodiments, the host device includes a clock module and a baseboard management controller BMC; and the clock module is connected to the high-speed optical communication connector QSFP28-PCIE through a high-speed serial computer expansion bus, the high-speed optical communication connector QSFP28-PCIE is connected to the field programmable gate array FPGA through the high-speed serial computer expansion bus, and the baseboard management controller BMC is connected to the field programmable gate array FPGA; and the clock module is configured to generate the negative clock signal CLK_N and the positive clock signal CLK_P, and transmit the negative clock signal CLK_N and the positive clock signal CLK_P to the high-speed optical communication connector QSFP28-PCIE based on the high-speed serial computer expansion bus.

In some embodiments, the host device includes a clock module, a baseboard management controller BMC, and a central processing unit CPU; the clock module is connected to the high-speed optical communication connector QSFP28-PCIE through a high-speed serial computer expansion bus, the central processing unit CPU is connected to the high-speed optical communication connector QSFP28-PCIE through the high-speed serial computer expansion bus, and the baseboard management controller BMC is connected to the high-speed optical communication connector QSFP28-PCIE; and the clock module is configured to generate the negative clock signal CLK_N and the positive clock signal CLK_P, and transmit the negative clock signal CLK_N and the positive clock signal CLK_P to the high-speed optical communication connector QSFP28-PCIE based on the high-speed serial computer expansion bus.

In some embodiments, the non-transitory memory express (NVMe) device is another storage server provided with a solid state disk that supports non-transitory memory express NVMe.

In some embodiments, the non-transitory memory express (NVMe) device is a mobile solid state disk supporting non-transitory memory express NVMe and a hot-swappable function.

An embodiment of the present application provide a server, wherein the server is configured with a high-speed optical communication connector QSFP28-PCIE, wherein the high-speed optical communication connector QSFP28-PCIE is configured to connect the server and an optical module device or connect the server and a non-transitory memory express (NVMe) device; and the server is configured to generate a module low-speed signal MODSEL and an optical module reset signal, or to generate a negative clock signal CLK_N and a positive clock signal CLK_P. The high-speed optical communication connector QSFP28-PCIE includes:
a first signal pin for the module low-speed signal MODSEL or the negative clock signal CLK_N;
a second signal pin for the optical module reset signal or the positive clock signal CLK_P;
the first signal pin is configured to transmit the module low-speed signal MODSEL transmitted by the server to the optical module device when the server is connected to the optical module device;
the first signal pin is configured to transmit the negative clock signal CLK_N transmitted by the server to the non-transitory memory express (NVMe) device when the server is connected to the non-transitory memory express (NVMe) device;
the second signal pin is configured to transmit the optical module reset signal transmitted by the server to the optical module device when the server is connected to the optical module device; and
the second signal pin is configured to transmit the positive clock signal CLK_P transmitted by the server to the non-transitory memory express (NVMe) device when the server is connected to the non-transitory memory express (NVMe) device.

In some embodiments, the server is provided with a field programmable gate array FPGA that is configured to receive an in-place detection input signal MODPRSL generated by the optical module device or the non-transitory memory express (NVMe) device, and when receiving the in-place detection input signal MODPRSL, the field programmable gate array FPGA is configured to establish a connection relationship between the server and the optical module device based on the in-place detection input signal MODPRSL, or establish a connection relationship between the server and the non-transitory memory express (NVMe) device based on the in-place detection input signal MODPRSL.

In some embodiments, including:
a third signal pin, configured to supply a signal receiving power voltage VCCRX;
a fourth signal pin, configured to supply a signal transmission power voltage VCCTX; and
a fifth signal pin, configured to supply a low-speed signal power voltage VCC1.

In some embodiments, the server is configured to generate a linear polarization mode signal LPMODE or a peer device reset signal, and the high-speed optical communication connector QSFP28-PCIE includes:
a sixth signal pin for the linear polarization mode signal LPMODE or the peer device reset signal;
the sixth signal pin is configured to transmit the linear polarization mode signal LPMODE transmitted by the server to the optical module device when the server is connected to the optical module device; and
the sixth signal pin is configured to transmit a peer device reset signal transmitted by the server to the non-transitory memory express (NVMe) device when the server is connected to the non-transitory memory express (NVMe) device.

In some embodiments, the server is configured to generate a terminal alarm signal INTC or a wake-up signal WAKE, and the high-speed optical communication connector QSFP28-PCIE includes:
a seventh signal pin for the terminal alarm signal INTC or the wake-up signal WAKE;
the seventh signal pin is configured to transmit the terminal alarm signal INTC transmitted by the server to the optical module device when the server is connected to the optical module device; and
the seventh signal pin is configured to transmit the wake-up signal WAKE transmitted by the server to the non-transitory memory express (NVMe) device when the server is connected to the non-transitory memory express (NVMe) device.

In some embodiments, the optical module device and the high-speed optical communication connector QSFP28-PCIE includes:
an eighth signal pin for the in-place detection input signal MODPRSL;
the eighth signal pin is configured to transmit the in-place detection input signal MODPRSL to the server.

In some embodiments, the server includes a clock module and a baseboard management controller BMC; and the clock module is connected to the high-speed optical communication connector QSFP28-PCIE through a high-speed serial computer expansion bus, the high-speed optical communication connector QSFP28-PCIE is connected to the field programmable gate array FPGA through the high-speed serial computer expansion bus, and the baseboard management controller BMC is connected to the field programmable gate array FPGA; and the clock module is configured to generate the negative clock signal CLK_N and the positive clock signal CLK_P, and transmit the negative clock signal CLK_N and the positive clock signal CLK_P to the high-speed optical communication connector QSFP28-PCIE based on the high-speed serial computer expansion bus.

In some embodiments, the server includes a clock module, a baseboard management controller BMC, and a central processing unit CPU; the clock module is connected to the high-speed optical communication connector QSFP28-PCIE through a high-speed serial computer expansion bus, the central processing unit CPU is connected to the high-speed optical communication connector QSFP28-PCIE through the high-speed serial computer expansion bus, and the baseboard management controller BMC is connected to the high-speed optical communication connector QSFP28-PCIE; and the clock module is configured to generate the negative clock signal CLK_N and the positive clock signal CLK_P, and transmit the negative clock signal CLK_N and the positive clock signal CLK_P to the high-speed optical communication connector QSFP28-PCIE based on the high-speed serial computer expansion bus.

In some embodiments, the non-transitory memory express (NVMe) device is another storage server provided with a solid state disk that supports non-transitory memory express NVMe.

In some embodiments, the non-transitory memory express (NVMe) device is a mobile solid state disk supporting non-transitory memory express NVMe and a hot-swappable function.

The embodiments of the present application have the following advantages:
according to the embodiments of the present application, multiplexing of the module low-speed signal MODSEL and the negative clock signal is achieved through the first signal pin, and multiplexing of the optical module reset signal or the positive clock signal is achieved through the second signal pin, such that the high-speed optical communication connector including the first signal pin and the second signal pin may be compatible with optical signal data transmission and peripheral component interconnect express (PCI-Express) protocol signal transmission simultaneously. Consequently, peripheral component interconnect express (PCIe) bus data may be transmitted over a long distance based on an existing optical fiber network, thereby improving transmission efficiency of the peripheral component interconnect express (PCIe) bus data, and avoiding resource wastes of an existing network infrastructure.

### BRIEF DESCRIPTION OF THE DRAWINGS

In order to provide a clearer explanation of some embodiments of the present application, a brief introduction will be given below to the drawings required for use in some embodiments. It is obvious that the drawings described below are only some embodiments of the present application. For those skilled in the art, other drawings may be obtained based on these drawings without creative work.

FIG. 1 is a schematic structural diagram of a high-speed optical communication connector according to an embodiment of the present application;

FIG. 2 is a schematic structural diagram of another high-speed optical communication connector according to an embodiment of the present application;

FIG. 3 is a schematic structural diagram of a local host device and a peer device according to an embodiment of the present application;

FIG. 4 is a schematic structural diagram of another local host device and a peer device according to an embodiment of the present application; and

FIG. 5 is a schematic structural diagram of yet another local host device and a peer device according to an embodiment of the present application.

### DETAILED DESCRIPTION

In order to make the above objectives, features, and advantages of the present application more obvious and understandable, the following will provide further detailed explanations of the present application in conjunction with the accompanying drawings and specific implementation methods.

In practical applications, a solid state disk or a solid state drive (SSD) employs a flash memory as a storage medium, with a reading speed higher than that of a mechanical hard disk, such that the solid state disk is expected to be a preferred configuration for a data center and cloud computing in a storage field in future due to its high-efficiency storage performance and saved energy consumption costs. Solid state disk interface types are divided into a serial advanced technology attachment (SATA) bus interface and a peripheral component interconnect express (PCIe) bus-based non-transitory memory express (NVMe) protocol bus interface according to a protocol. Non-transitory memory express (NVMe) is an industry standard specially designed for the solid state disk (SSD) with a PCIe interface, and storage architectures of conventional solid state disks (SSDs) with SATA and serial attached small computer system interface (SCSI) (SAS) interfaces are replaced through high bandwidth and low delay of the PCIe bus, such that the solid state disk with the PCIe interface has a higher read/write speed, lower delay, and lower power consumption, making it a mainstream development trend in the future of storage industry. A connector forms of connecting the solid state disk and a motherboard PCIe interface comes in various interface forms, including U.2 and M.2. These interfaces are predominantly designed as dedicated interfaces for storage purposes, with limited capability for concurrent multiplexing into other functions.

In the fast-evolving times of big data networks, the proportion of real-time data is becoming increasingly critical. Sometimes, a host needs to engage in more network interactions, necessitating increased network bandwidth. As the network bandwidth increases, larger data storage space is required. However, the network bandwidth and data storage are not in equal relation. At certain stages, network data needs to be stored, imposing a requirement for the larger storage space. Nevertheless, the stored data often has a short validity period, after which the storage space may be freed up, namely, the large storage space is not required. This creates a situation, wherein at times, storage applications take priority, and at other times, the network bandwidth needs take precedence. In this case, a personal computer (PC) host or a server system needs to be equipped with more network interfaces, switches, and storage interfaces, or even deploy large-scale distributed networks.

By implementing a compatible design between a high-speed optical communication interface and a PCIe interface, which represent two cornerstone technologies in the fields of networking and storage, convergence of network and storage functionalities is achieved at the interfaces. Based on this design, a new application mode may emerge for providing optional network expansion or storage expansion to the PC host, supporting plug-and-play functionality without need to shut down to maintain and replace interfaces.

Therefore, embodiments of the present application propose a high-speed optical communication connector QSFP28-PCIE that supports a PCIe protocol, enabling a mainstream 100 G QSFP28 network interface to be compatible with the PCIe interface, thereby allowing the network interface and an NVMe-based hard disk interface to be compatible with a same physical interface. This further facilitates fusion of the network and the storage at the interface, enabling free switching between two cornerstone data transmission technologies: an optical communication protocol and the PCIe protocol across different application scenarios.

FIG. 1 is a schematic structural diagram of a high-speed optical communication connector provided by embodiments of the present application.

In practical applications, the host device may be a server or a personal computer PC.

In particular implementations, the high-speed optical communication connector may be configured to connect the host device and the optical module device, or to connect the host device and the non-transitory memory express device. Exemplarily, the optical module device may be a device such as an optical interface switch that transmits data through an optical signal, and the non-transitory memory express device may be a device configured with the solid state disk (SSD), and the like that conforms to the non-transitory memory express.

When the host device is connected to the optical module device, the host device may be configured to generate a module low-speed signal MODSEL and an optical module reset signal RESET.

When the host device is connected to the non-transitory memory express device, the host device may be configured to generate a negative clock signal CLK_N and a positive clock signal CLK_P.

In practical applications, a primary difference between the PCIe interface and the optical communication interface is that the PCIe interface generally needs a pair of external 100 MHz reference clock signals. According to the embodiments of the present application, the MODSEL and RESET signals of the high-speed optical communication connector may be multiplexed into a reference clock output signal, so as to provide a 100 MHz reference clock for an NVMe hard disk.

The high-speed optical communication connector according to the embodiments of the present application may include:
a first signal pin 101 for the module low-speed signal MODSEL or the negative clock signal CLK_N; and
a second signal pin 102 for the optical module reset signal RESET or the positive clock signal CLK_P.

The first signal pin 101 is configured to transmit the module low-speed signal MODSEL transmitted by the host device to the optical module device when the host device is connected to the optical module device;

the second signal pin 102 is configured to transmit the optical module reset signal RESET transmitted by the host device to the optical module device when the host device is connected to the optical module device;

the first signal pin 101 is configured to transmit the negative clock signal transmitted by the host device to the non-transitory memory express device when the host device is connected to the non-transitory memory express device; and the second signal pin 102 is configured to transmit the positive clock signal transmitted by the host device to the non-transitory memory express device when the host device is connected to the non-transitory memory express device.

In a specific implementation, according to the embodiments of the present application, devices such as QSFP28 or QSFP56 may serve as an initial high-speed optical communication connector, and relevant signal definitions of a PCIE X4 interface are added on the basis of the initial high-speed optical communication connector, thereby implementing physical interface compatibility. To facilitate a better understanding of the embodiments of the present application for those skilled in the art, the following descriptions take QSFP28-PCIE as an example of the high-speed optical communication connector for illustration.

In the high-speed optical communication connector QSFP28-PCIE, as shown in FIG. 1, an input/output mode of an optical signal is compatible with an input/output mode of the PCIe interface, and a redefinition of a compatible PCIe interface signal may be made, among them, a high-speed signal line, an inter-integrated circuit (I2C) bus, a power supply, and most signal definitions and usages are the same for both QSFP28 and PCIe, interface level standards are almost identical, for example, signal lines of the QSFP28 interface and the PCIe interface are all high-speed serial buses, and are divided into four sets of unidirectional input RX [1:4] differential buses and four sets of unidirectional output TX [1:4] differential buses, and a bus specification may be identical to a specification of the QSFP28 interface.

The QSFP28 high-speed connector supports an interface line speed that reaches a maximum of 28 G signal rate, and may be downward compatible with a PCIe 4.0 interface, supporting a 16 G signal rate. A signal form of the high-speed connector is available, protocol compatibility may be achieved by applying a redefined interface at a host or a switch, a definition of a pin protocol may be achieved by a field programmable gate array (FPGA), thereby enabling interface application to be freely selected by the field programmable gate array (FPGA), and consequently, a seamless compatibility design may be achieved. For example, the field programmable gate array (FPGA) may define the high-speed optical communication connector QSFP28-PCIE to support a free switching between an optical port protocol and a PCIe protocol in a same physical port, including a definition of the first signal pin of the high-speed optical communication connector QSFP28-PCIE for multiplexing the module low-speed signal or the negative clock signal, and the second signal pin for multiplexing the optical module reset signal or the positive clock signal, which may be implemented within a field programmable gate array (FPGA) main controller.

In some embodiments, a channel selection for the optical module device and the non-transitory memory express device may be implemented through two methods.
I. Signal gating is performed through hardware gating, namely a resistor or a capacitor module, or through a high-speed analog switch.
II. A compatibility selection is performed through signals in a central processing unit (CPU) controller or an FPGA controller. In some embodiments, the FPGA, as a programmable module, offers a greater advantage when a CPU has not yet developed such a function. The FPGA module may define a high-speed signal channel as either a PCIe interface channel or an optical port Ethernet high-speed signal channel as needed. This means that a high-speed signal line from the connector only needs to be connected to the FPGA high-speed signal channel, and then, the FPGA defines whether the interface is a high-speed network interface or a PCIe bus interface based on actual applications.

Certainly, the above-mentioned example is merely for illustration. Those skilled in the art may implement the channel selection for the QSFP28 interface and the PCIe interface by any other methods, which are not limited to the embodiments of the present application.

When determining that the host device is connected to the optical module device, the module low-speed signal MODSEL and the optical module reset signal RESET are input signals with respect to the optical module. The signals may be pulled up to a volt current condenser (VCC) power supply of an optical module, for example, through a pull-up resistor, and when the host device outputs a low level to the optical module, the optical module is either selected or reset.

When determining that the host device is connected to the non-transitory memory express device, the high-speed optical communication connector QSFP28-PCIE may receive the reference clock signal CLK_N (negative clock signal)/CLK_P (positive clock signal) from the host device, with the CLK_N (negative clock signal)/CLK_P (positive clock signal) being the input signal for an NVMe SSD hard disk.

As may be known from the above, no matter whether the high-speed optical communication connector QSFP28-PCIe according to the embodiments of the present application is externally connected with the optical module or the NVMe hard disk, both the CLK_N/MODSEL and CLK_P/RESET signals are the input signals with respect to an external device, and are output signals with respect to a motherboard of the high-speed optical communication connector QSFP28-PCIe according to the embodiments of the present application. Therefore, irrespective of whether an application function pertains to a PCIe bus or an optical port signal mode, connection to either interface may not cause any damage to the other.

In some embodiments, multiplexing of the module low-speed signal MODSEL and the negative clock signal is achieved through the first signal pin, and multiplexing of the optical module reset signal or the positive clock signal is achieved through the second signal pin, such that the high-speed optical communication connector including the first signal pin and the second signal pin may be compatible with optical signal data transmission and peripheral component interconnect express (PCI-Express) protocol-based signal transmission simultaneously. Consequently, PCIe bus data may be transmitted over a long distance based on an existing optical fiber network, thereby improving transmission efficiency of the PCIe bus data and avoiding resource wastes of an existing network infrastructure.

On the basis of the above-mentioned embodiments, modified embodiments of the above-mentioned embodiments are proposed. It should be noted here that only differences from the above-mentioned embodiments are merely described in the modified embodiments for the sake of brevity of description.

In some embodiments of the present application, the host device is provided with the field programmable gate array, configured to receive an in-place detection input signal generated by the optical module device or the non-transitory memory express device, and when receiving the in-place detection input signal, establish a connection relationship between the host device and the optical module device based on the in-place detection input signal, or a connection relationship between the host device and the non-transitory memory express device based on the in-place detection input signal.

In practical applications, the field programmable gate array (FPGA) is a product which is further developed on the basis of programmable array logic (PAL), general array logic (GAL), and other programmable modules. The FPGA emerges as a semi-custom circuit in the field of application-specific integrated circuits (ASICs), addressing shortcomings of custom circuits while overcoming defects in a limited number of original programmable modules, such as gate circuits.

As may be known from the above, the programmable array logic FPGA, as the programmable module, offers a greater advantage when the CPU has not yet developed the channel selection function. The FPGA module may define the high-speed signal channel as either the PCIe interface channel or the optical port Ethernet high-speed signal channel as needed. This means that the high-speed signal line from the connector only needs to be connected to the field programmable gate array (FPGA) high-speed signal channel, and then, the field programmable gate array (FPGA) defines whether the interface is the high-speed network interface or the PCIe bus interface based on the actual applications.

In some embodiments, when the optical module device or the non-transitory memory express device generates the in-place detection input signal MODPRSL, the field programmable gate array (FPGA) may receive the in-place detection input signal MODPRSL; in response to the optical module connected to the host device, the in-place detection input signal MODPRSL may be grounded in the optical module device and is pulled up through the host device, and the host device is connected to input/output IO of the field programmable gate array (FPGA) to determine that an in-place device is the optical module device; and in response to non-transitory memory express device connected to the host device, the in-place detection input signal MODPRSL may be grounded in the non-transitory memory express device and is pulled up through the host device, and the host device is connected to the input/output IO of the field programmable gate array (FPGA) to determine that the in-place device is the non-transitory memory express device, thereby implementing compatibility of two transmission protocols.

In some embodiments, an analog output of an input/output IO signal at the host device may be selected by the FPGA to achieve compatibility of the clock signal with the MODSEL signal and the RESET signal (CLK_N/MODSEL and CLK_P/RESET). Since for the optical module, MODSEL and RESET are input signals, even when the FPGA is configured in a PCIe interface status, the outputted clock signal is connected to the optical module, and no damage is caused to either the optical module or the field programmable gate array (FPGA).

In some embodiments of the present application, the host device is provided with the field programmable gate array, configured to receive the in-place detection input signal generated by the optical module device or the non-transitory memory express device, and when receiving the in-place detection input signal, establish the connection relationship between the host device and the optical module device based on the in-place detection input signal, or the connection relationship between the host device and the non-transitory memory express device based on the in-place detection input signal, thereby improving channel selection efficiency of the optical module device and the non-transitory memory express device, and further improving data transmission efficiency.

In some embodiments of the present application, the high-speed optical communication connector includes:
an eighth signal pin for the in-place detection input signal; and
the eighth signal pin is configured to transmit the in-place detection input signal to the host device.

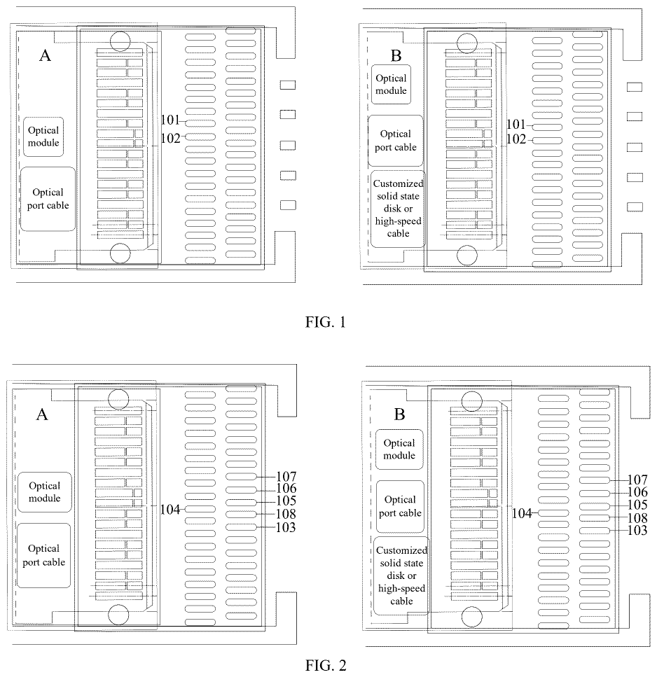

FIG. 2 is a schematic structural diagram of another high-speed optical communication connector provided by some embodiments of the present application.

In a specific implementation, according to some embodiments of the present application, the eighth signal pin 103 may be defined through the field programmable gate array (FPGA), such that the in-place detection input signal for the optical module device and the in-place detection input signal for the non-transitory memory express device may be multiplexed on the eighth signal pin 103. This allows both the in-place detection input signal for the optical module device and the in-place detection input signal for the non-transitory memory express device to be transmitted to the host device through the eighth signal pin 103, thereby saving pin occupation for the high-speed optical communication connector and further improving data transmission efficiency.

In some embodiments of the present application, the high-speed optical communication connector includes:
a third signal pin, configured to supply a signal receiving power voltage;
a fourth signal pin, configured to supply a signal transmission power voltage; and
a fifth signal pin, configured to supply a low-speed signal power voltage.

In practical applications, the I2C bus is a simple, bidirectional two-wire synchronous serial bus. The bus requires only two wires to transmit information between modules connected to the bus. A master module is configured to initiate data transmission over the bus and generate a clock to enable transmission. At this time, any addressed device is considered a slave module. A relationship between master and slave, and between transmitting and receiving, is not constant on the bus, which depends on a direction of data transmission at a given time. In response to that the master module transmits data to the slave module, the master module first addresses the slave module, then actively transmits the data to the slave module, and finally terminates the data transmission. Conversely, in response to that the master module receives the data from the slave module, the master module initially addresses the slave module, then receives the data transmitted by the slave module, and finally terminates a receiving process. In this case, the master module is responsible for generating a timing clock and terminating the data transmission.

The solid state disk (SSD), also referred to as the solid state drive, is a hard disk made of solid-state electronic storage arrays.

In specific implementations, the host device supplies power to the optical module device through three 3.3V power supplies at the receiving power voltage VCCRX, the transmitting power voltage VCCTX, and the low-speed signal power voltage VCC1, each power supply operates at a range of 3.3V ±5%, with power ranging from 1.5 W to 10 W. For power supply of the non-transitory memory express device, these three paths of the power supplies may be multiplexed for supplying power to the SSD hard disk, and the SSD hard disk also requires a power supply voltage of 3.3V ±5%. Depending on different capacities and speeds of the SSD hard disk, power consumption of the SSD hard disk generally ranges from approximately 2 to 10 W. A serial clock line (SCL)/serial data line (SDA) of the I2C bus has a same signal application mode, with an average interface voltage being 3.3V. A protocol standard follows a general I2C protocol standard, allowing the FPGA to simulate the I2C bus to read information from the optical module or the NVMe SSD hard disk, namely, an I2C bus signal may be fully compatible for use.

FIG. 2 is a schematic structural diagram of another high-speed optical communication connector provided by some embodiments of the present application;

The high-speed optical communication connector may include the third signal pin 104 for supplying the signal receiving power voltage VCCRX, the fourth signal pin 105 for supplying the signal transmission power voltage VCCTX, and the fifth signal pin 106 for supplying the low-speed signal power voltage VCC1, thereby achieving multiplexing of the power supply pins for the optical module device and the non-transitory memory express device, saving pin occupation for the high-speed optical communication connector, and further improving the data transmission efficiency.

In some embodiments of the present application, the host device is configured to generate a linear polarization mode signal or a peer device reset signal, and the high-speed optical communication connector includes:
a sixth signal pin for the linear polarization mode signal or the peer device reset signal, wherein
the sixth signal pin is configured to transmit the linear polarization mode signal transmitted by the host device to the optical module device when the host device is connected to the optical module device; and
the sixth signal pin is configured to transmit the peer device reset signal transmitted by the host device to the non-transitory memory express device when the host device is connected to the non-transitory memory express device.

In practical applications, the line polarization mode signal LPMODE of the optical module device is multiplexed as the peer device reset signal RESET of the PCIe interface, and the CPU or the FPGA may output the reset signal to the NVMe SSD hard disk. When the host device is connected to the optical module device, the CPU/FPGA outputs a signal to the optical module for selecting an operating mode of the optical module. The signal, whether serving as the linear polarization mode signal LPMODE or the peer device reset signal RESET, is considered an output signal for a QSFP28-PCIe interface motherboard in the present application, which may not cause any damage to the host device and the optical module device due to errors caused by different functions.

FIG. 2 is a schematic structural diagram of another high-speed optical communication connector provided by some embodiments of the present application.

According to the embodiments of the present application, the sixth signal pin 107 may be defined through the field programmable gate array (FPGA), such that the linear polarization mode signal LPMODE of the optical module and the peer device reset signal RESET of the PCIe interface are multiplexed on the sixth signal pin 107. This allows, when the host device is connected to the optical module device, the linear polarization mode signal transmitted by the host device to be transmitted to the optical module device through the sixth signal pin 107; and when the host device is connected to the non-transitory memory express device, the peer device reset signal transmitted by the host device to be transmitted to the non-transitory memory express device through the sixth signal pin 107.

According to the embodiments of the present application, the sixth signal pin is configured for the linear polarization mode signal or the peer device reset signal through the high-speed optical communication connectors; the sixth signal pin is configured to transmit the linear polarization mode signal transmitted by the host device to the optical module device when the host device is connected to the optical module device and to transmit the peer device reset signal transmitted by the host device to the non-transitory memory express device when the host device is connected to the non-transitory memory express device, such that the linear polarization mode signal LPMODE of the optical module and the peer device reset signal RESET of the PCIe interface are multiplexed on the sixth signal pin 107, thereby saving the pin occupation for the high-speed optical communication connector, and further improving the data transmission efficiency.

In some embodiments of the present application, the host device is configured to generate a terminal alarm signal or a wake-up signal, and the high-speed optical communication connector includes:
a seventh signal pin for the terminal alarm signal or the wake-up signal, wherein
the seventh signal pin is configured to transmit the terminal alarm signal transmitted by the host device to the optical module device when the host device is connected to the optical module device; and
the seventh signal pin is configured to transmit the wake-up signal transmitted by the host device to the non-transitory memory express device when the host device is connected to the non-transitory memory express device.

In practical applications, the terminal alarm signal INTC of the optical module device is an OD (open drain) output signal in the optical module device, and an alarm signal of a PCIe module is also an OD output signal; and the terminal alarm signal INTC/wake-up signal WAKE is multiplexed with the CPU/FPGA and is used as the alarm signal and wake-up signal WAKE of the optical module.

FIG. 2 is a schematic structural diagram of another high-speed optical communication connector provided by some embodiments of the present application.

According to the embodiments of the present application, the seventh signal pin 108 may be defined through the field programmable gate array (FPGA), such that the terminal alarm signal INTC of the optical module and the wake-up signal WAKE of the PCIe interface are multiplexed on the seventh signal pin 108. This allows, when the host device is connected to the optical module device, the terminal alarm signal INTC transmitted by the host device to be transmitted to the optical module device through the seventh signal pin 108; and when the host device is connected to the non-transitory memory express device, the wake-up signal transmitted by the host device is transmitted to the non-transitory memory express device through the seventh signal pin 108.

In some embodiments of the present application, the seventh signal pin is configured for the terminal alarm signal or the wake-up signal through the high-speed optical communication connector; the seventh signal pin is configured to transmit the terminal alarm signal transmitted by the host device to the optical module device when the host device is connected to the optical module device and to transmit the wake-up signal transmitted by the host device to the non-transitory memory express device when the host device is connected to the non-transitory memory express device, such that the terminal alarm signal INTC of the optical module and the wake-up signal WAKE of the PCIe interface are multiplexed on the seventh signal pin 108, thereby saving the pin occupation for the high-speed optical communication connector, and further improving the data transmission efficiency.

In some embodiments of the present application, the host device includes a clock module and a baseboard management controller; and the clock module is connected to the high-speed optical communication connector through a high-speed serial computer expansion bus, the high-speed optical communication connector is connected to the field programmable gate array through the high-speed serial computer expansion bus, and the baseboard management controller is connected to the field programmable gate array; and the clock module is configured to generate the negative clock signal and the positive clock signal and transmit the negative clock signal and the positive clock signal to the high-speed optical communication connector based on the high-speed serial computer expansion bus.

The baseboard management controller (BMC) is a specialized service processor that uses a sensor to monitor a status of a computer, a network server, or other hardware-driven devices.

FIG. 3 is a schematic structural diagram of a local host device and a peer device provided by some embodiments of the present application.

The peer device 301 may be a conventional 100 G QSFP28 optical interface switch, a QSFP28-PCIe interface switch, an optical communication device, a PCIe switch, a remote PCIe interface device, an NVMe interface hard disk, a storage server, or a conventional 100 G QSFP28 optical interface switch.

The peer device 301 may be configured with the high-speed optical communication connectors (QSFP28-PCIe interfaces) 3011.

In some embodiments, when the peer device is the non-transitory memory express device, the non-transitory memory express device is another storage server provided with the solid state disk that supports non-transitory memory express.

The host device 302 may include the clock module 3021 and the baseboard management controller 3022, the clock module 3021 is connected to the high-speed optical communication connectors (QSFP28-PCIe interfaces) 303, the high-speed optical communication connectors (QSFP28-PCIe interfaces) 303 are connected to the field programmable gate array (FPGA) 3023 through high-speed serial computer expansion bus including a low-speed signal line and a high-speed signal line, and the baseboard management controller 3022 is connected to the field programmable gate array (FPGA) 3023 through the low-speed signal line, so as to monitor the field programmable gate array (FPGA) 3023 through the baseboard management controller 3022.

PCIe optical modules 304 may be disposed between the peer device 301 and the host device 302, and data transmission may be performed between the peer device 301 and the host device 302 through the high-speed optical communication connectors (QSFP28-PCIe interfaces) 303, the high-speed optical communication connectors (QSFP28-PCIe interfaces) 3011, and the PCIe modules 304.

The host device 302 may be connected to the high-speed optical communication connectors through the field programmable gate array (FPGA) 3023 to achieve data interaction with the peer device 301 over PCIe or Ethernet.

The clock module 3021 is configured to generate the negative clock signal and the positive clock signal and transmit the negative clock signal and the positive clock signal (PCIe Refclk, reference clock) to the high-speed optical communication connectors (QSFP28-PCIe interfaces) 303 based on the high-speed serial computer expansion bus.

A central processing unit (CPU) serves as an operation and control core of a computer system and is a final execution unit for information processing and program running. As of generation of the CPU, great development has been made in logic structures, operation efficiency, and functional extension.

The field programmable gate array (FPGA) 3023 and the central processing unit (CPU) 3024 are connected through a PCIe 4.0×8 data bus.

The clock module 3021 is configured to transmit an SYS Refclk system reference clock signal to the central processing unit (CPU) 3024.

In practical applications, according to the embodiments of the present application, an Ethernet physical layer (PHY) controller is replaced with an Agilex FPGA controller to implement a PCIe-to-Ethernet function, and meanwhile, the QSFP28-PCIE interfaces according to the embodiments of the present application are adopted, such that compatibility with a PCIe data bus channel is achieved. A high-speed I/O data bus of the Agilex FPGA controller may achieve compatibility for both a PCIe bus protocol and an Ethernet bus protocol on a same interface. This enables a high-speed bus hardware compatibility design for the QSFP28-PCIE interfaces. According to the embodiments of the present application, the QSFP28-PCIE interfaces not only support compatibility with a conventional Ethernet interface design, but may also, through the FPGA as a bridge, achieve direct connection to remote devices via the PCIe bus, which overcomes defects of short transmission distance of the PCIe bus, thereby implementing function switching at the FPGA while allowing the compatibility design of the QSFP28 interfaces to support a design of PCIe protocol-based QSFP28 optical modules.

In some embodiments of the present application, the host device includes the clock module, the baseboard management controller, and the central processing unit; the clock module is connected to the high-speed optical communication connectors through the high-speed serial computer expansion bus, the central processing unit is connected to the high-speed optical communication connectors through the high-speed serial computer expansion bus, and the baseboard management controller is connected to the high-speed optical communication connectors; and the clock module is configured to generate the negative clock signal and the positive clock signal and transmit the negative clock signal and the positive clock signal to the high-speed optical communication connectors based on the high-speed serial computer expansion bus.

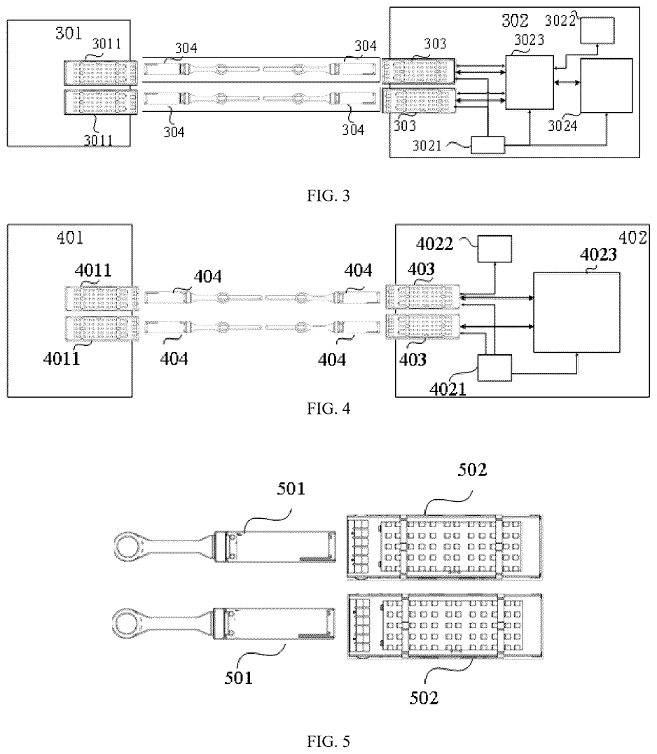

FIG. 4 is a schematic structural diagram of another local host device and peer device provided by some embodiments of the present application.

The peer device 401 may be the conventional 100 G QSFP28 optical interface switch, the QSFP28-PCIe interface switch, the optical communications device, the PCIe switch, the remote PCIe interface device, the NVMe interface hard disk, the storage server, or the conventional 100 G QSFP28 optical interface switch.

The peer device 401 may be configured with the high-speed optical communication connectors (QSFP28-PCIe interface) 4011.

In some embodiments, when the peer device is the non-transitory memory express device, the non-transitory memory express device is another storage server provided with the solid state disk that supports non-transitory memory express.

The host device 402 may include the clock module 4021 and the central processing unit (CPU) 4023, the clock module 4021 is connected to the high-speed optical communication connectors (QSFP28-PCIe interfaces) 403, the high-speed optical communication connectors (QSFP28-PCIe interfaces) 403 are connected to the central processing unit (CPU) 4023 through a high-speed serial computer expansion bus including a high-speed PCIe 4.0×4 data cable, and the baseboard management controller 4022 is connected to the high-speed optical communication connectors (QSFP28-PCIe interfaces) 403 through the low-speed signal line to monitor the high-speed optical communication connectors (QSFP28-PCIe interfaces) 403 through the baseboard management controller 4022.

The PCIe optical modules 404 may be disposed between the peer device 401 and the host device 402, and data transmission may be performed between the peer device 401 and the host device 402 through the high-speed optical communication connectors (QSFP28-PCIe interfaces) 403, the high-speed optical communication connectors (QSFP28-PCIe interfaces) 4011, and the PCIe modules 404.

The clock module 4021 is configured to generate the negative clock signal and the positive clock signal and transmit the negative clock signal and the positive clock signal (PCIe Refclk, reference clock) to the high-speed optical communication connectors (QSFP28-PCIe interfaces) 403 based on the high-speed serial computer expansion bus.

The clock module 4021 is configured to transmit the SYS Refclk system reference clock signal to the central processing unit (CPU) 4023.

In a specific implementation, according to the embodiments of the present application, a PHY transformation function of the FPGA may be simplified, and a long-distance transmission of the PCIe bus is achieved by the native PCIe interface of the CPU through the QSFP28-PCIe interfaces according to the embodiments of the present application, and data read/write delay is reduced greatly through a direct communication over the PCIe bus, thereby eliminating an intermediate PCIe-to-Ethernet conversion circuit, and greatly reducing design cost.

In some embodiments of the present application, the non-transitory memory express device is a mobile solid state disk supporting non-transitory memory express and a hot-swappable function.

FIG. 5 is a schematic structural diagram of yet another local host device and peer device provided by some embodiments of the present application.

The peer device may be a mobile solid state disk (SSD) 501 supporting the non-transitory memory express and the hot-swappable function. By directly adopting a physical structure of a QSFP28 module, a physical structure of an SSD solid state mobile disk socket is designed to be compatible with the high-speed optical communication connectors (QSFP28-PCIe interfaces) 502. As may be known from the above, the non-transitory memory express device may be powered by multiplexing three paths of power supplies as power supply of the solid state disk, the SSD hard disk also requires a power supply voltage of 3.3V ±5%, and the high-speed optical communication connectors (QSFP28-PCIe interfaces) 502 according to the embodiments of the present application may include the third signal pin for supplying the signal receiving power voltage; the fourth signal pin for supplying the signal transmission power voltage; the fifth signal pin for supplying the low-speed signal power voltage, namely, the high-speed optical communication connectors (QSFP28-PCIe interfaces) 502 according to the embodiments of the present application provide three 3.3V power supplies at the receiving power voltage VCCRX, the transmission power voltage VCCTX, and the low-speed signal power voltage VCC1; while achieving power supply compatibility, hot-swappable modules may be arranged additionally on the mobile solid state disks (SSDs) 501, enabling a QSFP28-SSD hard disk to support the hot-swappable function while being powered, and then, a PCIe specific channel is retrained and enumerated through system software, hot-swappable and plug-and-play functions of the solid state disk (SSD) may be achieved, thereby establishing a new mobile SSD hard disk interface form and a hard disk form.

In some embodiments, an interface A and an interface B in FIG. 1 and FIG. 2 may be a same interface, wherein the interface A represents a standard four-wire high-speed optical fiber transmission module interface definition, namely, the interface performs data interaction with other devices through pins under the standard four-wire high-speed optical fiber transmission module interface definition, the interface B represents a four-wire high-speed optical fiber transmission module interface definition compatible with a peripheral component interconnect express (PCIe) X4 interface, namely, the interface performs data interaction with other devices through pins under the definition of compatibility with the peripheral component interconnect express (PCIe) X4 interface. The interface B has a total of 38 pins, 19 pins on a left side arranged sequentially from top to bottom, and 19 pins on a right side arranged sequentially from bottom to top. These 38 pins may be labeled as pins 1-38. In practical applications, a transmitting (TX) signal is a differential bus output signal, and a receiving (RX) signal is a differential bus input signal, with P (positive) as positive and N (negative) as negative.

The pins 1-7, the pins 11-26, and the pins 32-38 in sequence may be assigned to the same signal. The pin 2 in sequence is for a TX2N signal, the pin 3 in sequence is for a TX2P signal, the pin 5 in sequence is for a TX4N signal, the pin 6 in sequence is for a TX4P signal, the pin 8 (a first pin 101) in sequence is for a multiplexed MODSEL signal and CLK_N signal, the pin 9 (a second pin 102) in sequence is for a multiplexed RESET signal and CLK_P signal, the pin 10 (a third signal pin 104) in sequence is for a VCCRX signal, the pin 11 in sequence is for an SCL signal, the pin 12 in sequence is for an SDA signal, the pin 14 in sequence is for an RX3P signal, the pin 15 in sequence is for an RX3N, the pin 17 in sequence is for an RX1P signal, the pin 18 in sequence is for an RXIN signal, the pin 21 in sequence is for an RX2N signal, the pin 22 in sequence is for an RX2P signal, the pin 24 in sequence is for an RX4N, the pin 25 in sequence is for an RX4P signal, the pin 27 (an eighth signal pin 103) in sequence is for an MODPRS signal, the pin 28 (a seventh signal pin 108) in sequence is for an INTC signal and a WAKE signal, the pin 29 (a fourth signal pin 105) in sequence is for a VCCTX signal, the pin 30 (a fifth signal pin 106) in sequence is for a VCC1 signal, the pin 31 (a sixth signal pin 107) in sequence is for a multiplexed LPMODE signal and RESET signal, the pin 33 in sequence is for a TX3P signal, the pin 34 in sequence is for a TX3N signal, the pin 36 in sequence is a TX1P signal, and the pin 37 in sequence is for a TXIN signal.

Some embodiments of the present application further disclose a server, wherein the server is configured with the high-speed optical communication connector QSFP28-PCIE, the high-speed optical communication connector QSFP28-PCIE is configured to connect the host device and the optical module device or to connect the server and the NVMe device; and the server is configured to generate the module low-speed signal MODSEL and the optical module reset signal, or to generate the negative clock signal CLK_N and the positive clock signal CLK_P. The high-speed optical communication connector QSFP28-PCIE includes:
the first signal pin for the module low-speed signal MODSEL or the negative clock signal CLK_N; and
the second signal pin for the optical module reset signal or the positive clock signal CLK_P;
the first signal pin is configured to transmit the module low-speed signal MODSEL transmitted by the server to the optical module device when the server is connected to the optical module device;
the first signal pin is configured to transmit the negative clock signal CLK_N transmitted by the server to the non-transitory memory express (NVMe) device when the server is connected to the non-transitory memory express (NVMe) device;
the second signal pin is configured to transmit the optical module reset signal transmitted by the server to the optical module device when the server is connected to the optical module device; and
the second signal pin is configured to transmit the positive clock signal CLK_P transmitted by the server to the non-transitory memory express (NVMe) device when the server is connected to the non-transitory memory express (NVMe) device.

In some embodiments of the present application, the server is provided with the field programmable gate array (FPGA), configured to receive the in-place detection input signal MODPRSL generated by the optical module device or the non-transitory memory express (NVMe) device, and when receiving the in-place detection input signal MODPRSL, establish a connection relationship between the host device and the optical module device based on the in-place detection input signal MODPRSL, or a connection relationship between the host device and the non-transitory memory express (NVMe) device based on the in-place detection input signal MODPRSL.

In some embodiments, the high-speed optical communication connector QSFP28-PCIE includes:
the third signal pin, configured to supply the signal receiving power voltage VCCRX;
the fourth signal pin, configured to supply the signal transmission power voltage VCCTX; and
the fifth signal pin, configured to supply the low-speed signal power voltage VCC1.

In some embodiments, the server is configured to generate the polarization mode signal QSFP28-PCIE or the peer device reset signal, and the high-speed optical communication connector includes:
the sixth signal pin for the linear polarization mode signal LPMODE or the peer device reset signal, wherein
the sixth signal pin is configured to transmit the linear polarization mode signal LPMODE transmitted by the server to the optical module device when the server is connected to the optical module device; and
the sixth signal pin is configured to transmit the peer device reset signal transmitted by the server to the non-transitory memory express (NVMe) device when the server is connected to the non-transitory memory express (NVMe) device.

In some embodiments, the server is configured to generate the terminal alarm signal INTC or the wake-up signal WAKE, and the high-speed optical communication connector QSFP28-PCIE includes:
the seventh signal pin for the terminal alarm signal INTC or the wake-up signal WAKE, wherein
the seventh signal pin is configured to transmit the terminal alarm signal INTC transmitted by the server to the optical module device when the server is connected to the optical module device; and
the seventh signal pin is configured to transmit the wake-up signal WAKE transmitted by the server to the non-transitory memory express (NVMe) device when the server is connected to the non-transitory memory express (NVMe) device.

In some embodiments, the optical module device and the high-speed optical communication connector QSFP28-PCIE include:
the eighth signal pin for the in-place detection input signal MODPRSL; and
the eighth signal pin is configured to transmit the in-place detection input signal MODPRSL to the server.

In some embodiments, the server includes the clock module and the baseboard management controller (BMC); the clock module is connected to the high-speed optical communication connector QSFP28-PCIE through the high-speed serial computer expansion bus, the high-speed optical communication connector QSFP28-PCIE is connected to the field programmable gate array (FPGA) through the high-speed serial computer expansion bus, and BMC is connected to the field programmable gate array (FPGA); and the clock module is configured to generate the negative clock signal CLK_N and the positive clock signal CLK_P and transmits the negative clock signal CLK_N and the positive clock signal CLK_N to the high-speed optical communication connector QSFP28-PCIE based on the high-speed serial computer expansion bus.

In some embodiments, the server includes the clock module, the baseboard management controller (BMC), and the central processing unit (CPU); the clock module is connected to the high-speed optical communication connector QSFP28-PCIE through the high-speed serial computer expansion bus, the central processing unit (CPU) is connected to the high-speed optical communication connector QSFP28-PCIE through the high-speed serial computer expansion bus, and the baseboard management controller (BMC) is connected to the high-speed optical communication connector QSFP28-PCIE; and the clock module is configured to generate the negative clock signal CLK_N and the positive clock signal CLK_P and transmit the negative clock signal CLK_N and the positive clock signal CLK_N to the high-speed optical communication connector QSFP28-PCIE based on the high-speed serial computer expansion bus.

In some embodiments, when the non-transitory memory express (NVMe) device is another storage server provided with the solid state disk that supports non-transitory memory express (NVMe).

In some embodiments, the non-transitory memory express (NVMe) device is the mobile solid state disk supporting the non-transitory memory express (NVMe) and the hot-swappable function.

Since the embodiment of the server is basically similar to embodiment of the high-speed optical communication connector, the description is kept relatively simple. For relevant details, references may be made to some descriptions in the embodiment of the high-speed optical communication connector.

Although preferred embodiments of the present application have been described, those skilled in the art may make additional changes and modifications to these embodiments once they have knowledge of the basic inventive concept. Therefore, the attached claims are intended to be interpreted as including preferred embodiments and all changes and modifications falling within the scope of the embodiments of the present application.

Finally, it should be noted that in this article, the terms “comprising/including”, “containing”, or any other variation thereof are intended to encompass non-exclusive inclusion, such that a process, method, item, or terminal device that includes a series of elements not only includes those elements, but also includes other elements not explicitly listed, or also includes elements inherent to such process, method, item, or terminal device. Without further limitations, the element defined by the statement “including a . . . ” does not exclude the existence of other identical elements in the process, method, item, or terminal device that includes the element in question.

The above is only a specific implementation of the present application, but the scope of protection of the present application is not limited to this. Any persons skilled in the art may easily think of changes or replacements within the technical scope disclosed in the present application, which should be included in the scope of protection of the present application. Therefore, the scope of protection of the present application should be based on the scope of protection of the claims.

1. A high-speed optical communication connector, wherein the high-speed optical communication connector is configured to connect a host device and an optical module device or connect the host device and a non-transitory memory express device; and the host device is configured to generate a module low-speed signal and an optical module reset signal, or to generate a negative clock signal and a positive clock signal, and the high-speed optical communication connector comprises:
a first signal pin for the module low-speed signal or the negative clock signal; and
a second signal pin for the optical module reset signal or the positive clock signal; wherein
the first signal pin is configured to transmit the module low-speed signal transmitted by the host device to the optical module device when the host device is connected to the optical module device;
the first signal pin is configured to transmit the negative clock signal transmitted by the host device to the non-transitory memory express device when the host device is connected to the non-transitory memory express device;
the second signal pin is configured to transmit the optical module reset signal transmitted by the host device to the optical module device when the host device is connected to the optical module device; and
the second signal pin is configured to transmit the positive clock signal transmitted by the host device to the non-transitory memory express device when the host device is connected to the non-transitory memory express device;
wherein the host device is configured to generate a linear polarization mode signal or a peer device reset signal, and the high-speed optical communication connector comprises:
a sixth signal pin for the linear polarization mode signal or the peer device reset signal;
wherein the sixth signal pin is configured to transmit the linear polarization mode signal transmitted by the host device to the optical module device when the host device is connected to the optical module device; and
the sixth signal pin is configured to transmit the peer device reset signal transmitted by the host device to the non-transitory memory express device when the host device is connected to the non-transitory memory express device.

2. The high-speed optical communication connector according to claim 1, wherein the host device is provided with a field programmable gate array that is configured to receive an in-place detection input signal generated by the optical module device or the non-transitory memory express device, and when receiving the in-place detection input signal, the field programmable gate array is configured to establish a connection relationship between the host device and the optical module device based on the in-place detection input signal, or establish a connection relationship between the host device and the non-transitory memory express device based on the in-place detection input signal.

3. The high-speed optical communication connector according to claim 1, comprising:
a third signal pin, configured to supply a signal receiving power voltage;
a fourth signal pin, configured to supply a signal transmission power voltage; and
a fifth signal pin, configured to supply a low-speed signal power voltage.

4. (canceled)

5. The high-speed optical communication connector according to claim 1, wherein the host device is configured to generate a terminal alarm signal or a wake-up signal, and the high-speed optical communication connector comprises:
a seventh signal pin for the terminal alarm signal or the wake-up signal; wherein
the seventh signal pin is configured to transmit a terminal alarm signal transmitted by the host device to the optical module device when the host device is connected to the optical module device; and
the seventh signal pin is configured to transmit a wake-up signal transmitted by the host device to the non-transitory memory express device when the host device is connected to the non-transitory memory express device.

6. The high-speed optical communication connector according to claim 2, comprising:
an eighth signal pin for the in-place detection input signal; wherein
the eighth signal pin is configured to transmit the in-place detection input signal to the host device.

7. The high-speed optical communication connector according to claim 6, wherein the host device comprises a clock module and a baseboard management controller; and the clock module is connected to the high-speed optical communication connector through a high-speed serial computer expansion bus, the high-speed optical communication connector is connected to the field programmable gate array through the high-speed serial computer expansion bus, and the baseboard management controller is connected to the field programmable gate array; and
the clock module is configured to generate the negative clock signal and the positive clock signal, and transmit the negative clock signal and the positive clock signal to the high-speed optical communication connector based on the high-speed serial computer expansion bus.

8. The high-speed optical communication connector according to claim 1, wherein the host device comprises a clock module, a baseboard management controller, and a central processing unit; the clock module is connected to the high-speed optical communication connector through a high-speed serial computer expansion bus, the central processing unit is connected to the high-speed optical communication connector through the high-speed serial computer expansion bus, and the baseboard management controller is connected to the high-speed optical communication connector; and
the clock module is configured to generate the negative clock signal and the positive clock signal, and transmit the negative clock signal and the positive clock signal to the high-speed optical communication connector based on the high-speed serial computer expansion bus.

9. The high-speed optical communication connector according to claim 7, wherein the non-transitory memory express device is another storage server provided with a solid state disk that supports non-transitory memory express.

10. The high-speed optical communication connector according to claim 7, or wherein the non-transitory memory express device is a mobile solid state disk supporting non-transitory memory express and a hot-swappable function.

11. A server, wherein the server is configured with a high-speed optical communication connector, the high-speed optical communication connector is configured to connect the server and an optical module device or connect the server and a non-transitory memory express device; and the server is configured to generate a module low-speed signal and an optical module reset signal, or to generate a negative clock signal and a positive clock signal, and the high-speed optical communication connector comprises:
a first signal pin for the module low-speed signal or the negative clock signal; and
a second signal pin for the optical module reset signal or the positive clock signal; wherein
the first signal pin is configured to transmit the module low-speed signal transmitted by the server to the optical module device when the server is connected to the optical module device;
the first signal pin is configured to transmit the negative clock signal transmitted by the server to a non-transitory memory express device when the server is connected to the non-transitory memory express device;
the second signal pin is configured to transmit the optical module reset signal transmitted by the server to the optical module device when the server is connected to the optical module device; and
the second signal pin is configured to transmit the positive clock signal transmitted by the server to the non-transitory memory express device when the server is connected to the non-transitory memory express device;
wherein the server is configured to generate a linear polarization mode signal or a peer device reset signal, and the high-speed optical communication connector comprises:
a sixth signal pin for the linear polarization mode signal or the peer device reset signal;
wherein the sixth signal pin is configured to transmit the linear polarization mode signal transmitted by the server to the optical module device when the server is connected to the optical module device; and
the sixth signal pin is configured to transmit the peer device reset signal transmitted by the server to the non-transitory memory express device when the server is connected to the non-transitory memory express device.

12. The server according to claim 11, wherein the server is provided with a field programmable gate array that is configured to receive an in-place detection input signal generated by the optical module device or the non-transitory memory express device, and when receiving the in-place detection input signal, the field programmable gate array is configured to establish a connection relationship between the server and the optical module device based on the in-place detection input signal, or establish a connection relationship between the server and the non-transitory memory express device based on the in-place detection input signal.

13. The server according to claim 11, wherein the high-speed optical communication connector comprises:
a third signal pin, configured to supply a signal receiving power voltage;
a fourth signal pin, configured to supply a signal transmission power voltage; and
a fifth signal pin, configured to supply a low-speed signal power voltage.

14. (canceled)

15. The server according to claim 11, wherein the server is configured to generate a terminal alarm signal or a wake-up signal, and the high-speed optical communication connector comprises:
a seventh signal pin for the terminal alarm signal or the wake-up signal;
wherein the seventh signal pin is configured to transmit a terminal alarm signal transmitted by the server to the optical module device when the server is connected to the optical module device; and
the seventh signal pin is configured to transmit a wake-up signal transmitted by the server to the non-transitory memory express device when the server is connected to the non-transitory memory express device.

16. The server according to claim 12, wherein the high-speed optical communication connector comprises:
an eighth signal pin for the in-place detection input signal; wherein
the eighth signal pin is configured to transmit the in-place detection input signal to the server.

17. The server according to claim 16, wherein the server comprises a clock module and a baseboard management controller; the clock module is connected to the high-speed optical communication connector through a high-speed serial computer expansion bus, the high-speed optical communication connector is connected to the field programmable gate array through the high-speed serial computer expansion bus, and the baseboard management controller is connected to the field programmable gate array; and
the clock module is configured to generate the negative clock signal and the positive clock signal, and transmit the negative clock signal and the positive clock signal to the high-speed optical communication connector based on the high-speed serial computer expansion bus.

18. The server according to claim 11, wherein the server comprises a clock module, a baseboard management controller, and a central processing unit; the clock module is connected to the high-speed optical communication connector through a high-speed serial computer expansion bus, the central processing unit is connected to the high-speed optical communication connector through the high-speed serial computer expansion bus, and the baseboard management controller is connected to the high-speed optical communication connector; and
the clock module is configured to generate the negative clock signal and the positive clock signal, and transmit the negative clock signal and the positive clock signal to the high-speed optical communication connector based on the high-speed serial computer expansion bus.

19. The server according to claim 17, wherein the non-transitory memory express device is another storage server provided with a solid state disk that supports non-transitory memory express.

20. The server according to claim 17, wherein the non-transitory memory express device is a mobile solid state disk supporting non-transitory memory express and a hot-swappable function.

21. The high-speed optical communication connector according to claim 1, wherein the module low-speed signal and the optical module reset signal are multiplexed into a reference clock output signal, to provide a 100 MHz reference clock for a non-transitory memory express hard disk.

22. The high-speed optical communication connector according to claim 2, wherein the field programmable gate array defines the first signal pin for multiplexing the module low-speed signal or the negative clock signal, and defines the second signal pin for multiplexing the optical module reset signal or the positive clock signal.
